(19) United States
(12) Patent Application Publication
(10) Pub. No.: US 2011/0097812 A1
(43) Pub. Date: Apr. 28, 2011

(54) GAS DETECTOR AND PROCESS FOR MONITORING THE CONCENTRATION OF A GAS

(75) Inventors: Wolfgang BÄTHER, Lubeck (DE); Stefan ZIMMERMANN, Reinfeld (DE)

(73) Assignee: DRAGERWERK AG & CO. KGAA, Lubeck (DE)

(21) Appl. No.: 12/853,577

(22) Filed: Aug. 10, 2010

(30) Foreign Application Priority Data
Oct. 28, 2009 (DE) 10 2009 051 069.9

(51) Int. Cl. G01N 27/62; G01N 27/00; B82Y 30/00

(52) U.S. Cl. 436/153; 422/98; 977/742

(57) ABSTRACT

A gas detector (25) has an electron source (1), which emits electron pulses into a reaction chamber (26) through a membrane (10). The ions formed in the reaction chamber (26) by the electron beam can be detected by means of a current detector (30) by a transfer field pulse being generated in the reaction chamber. The gas sensor (25) may have especially a miniaturized design.

### CROSS REFERENCE TO RELATED APPLICATIONS

This application claims the benefit of priority under 35 U.S.C. §119 of German Patent Application DE 10 2009 051 069.9 filed Oct. 28, 2009, the entire contents of which are incorporated herein by reference.

### FIELD OF THE INVENTION

The present invention pertains to a gas detector for monitoring the concentration of a gas with a reaction chamber, to which the gas to be monitored can be fed, a pulsable electron source, by which electrons can be emitted in electron pulses into the reaction chamber, a field generator, by which a pulsed electric transfer field can be generated in the reaction chamber, a current detector, by which an ionic current caused by the electrons in the reaction chamber and the transfer field in the reaction chamber can be detected, and with a measuring device, which is arranged downstream of the current detector and by which the ionic current can be quantitatively determined.

### BACKGROUND OF THE INVENTION

Such a gas detector is known from DE 10 2005 028 930 A1. The prior-art gas detector is preferably an ion mobility spectrometer (IMS), which has a reaction chamber and a drift space separated from the reaction chamber via a barrier grid. To form ions in the reaction chamber, the prior-art ion mobility spectrometer has an electron source, in which electrons are released in the vacuum, for example, according to the thermal method, the electrons are then brought to a correspondingly high energy level after passing through a potential difference and are finally emitted into the reaction chamber after passing through a very thin silicon nitride layer. The electrons can be introduced into the reaction chamber in electron pulses.

The electrons introduced into the reaction chamber ionize matrix molecules of the air in order to ultimately form hydronium ions. These in turn release a proton to analyte molecules with a sufficiently high proton affinity. The analyte ions formed in this manner in a gentle manner are transferred in the prior-art ion mobility spectrometer into the drift space by a voltage pulse applied to the barrier grid. The analyte ions are separated from one another based on their analyte-specific mobility by a drift field generated in the drift space and finally detected by a current detector arranged in the drift space at the end of the drift section.

Furthermore, the use of an electron source operated in a pulsed manner in an ion mobility spectrometer is considered to be known from patent application DE 10 2008 029 555.8 published later. The analyte ions formed in a reaction chamber are allowed here to recombine for different lengths of time, the analyte ions are transferred with an electric pulse into the drift tube of an ion mobility spectrometer and the analyte ions are analyzed on the basis of their mobility. Hydronium ions recombine within a very short time, whereas analyte ions, especially analyte ions of analytes with a high proton affinity, often have significantly longer recombination times. This is manifested in different ion mobility spectra depending on the recombination time.

Ion mobility spectrometers (IMS) and mass spectrometers (MS) are relatively complex and also very expensive. However, there are applications in which access to the highly sensitive protonation technique would be helpful but the selectivity of conventional ion mobility spectrometers can be readily dispensed with. At the same time, such a sensor system would have to be markedly more cost effective.

Such an application is, for example, a filter depletion indicator, which is able to recognize the breakthrough of highly toxic substances, for example, of chemical warfare agents, in the lower ppb range through filters.

### SUMMARY OF THE INVENTION

Based on this state of the art, the object of the present invention is therefore to provide a cost-effective, rapid but highly sensitive gas sensor especially for detecting analytes with high proton affinity in the lower ppb range.

According to the invention a gas detector is provided for monitoring the concentration of a gas. The gas detector has a reaction chamber, to which the gas to be monitored can be fed, a pulsable electron source, by which electrons can be emitted in electron pulses into the reaction chamber and a field generator, by which a pulsed electric transfer field can be generated in the reaction chamber. A current detector is provided, by which an ionic current caused by the electrons in the reaction chamber and the transfer field in the reaction chamber can be detected. A measuring device is arranged downstream of the current detector and by which the ionic current can be quantitatively determined. The current detector is arranged in the reaction chamber and that the pulsed transfer field extends up to the current detector.

According to another aspect of the invention, a process is provided for monitoring the concentration of a gas, in which the gas to be monitored is fed into the reaction chamber of a gas detector. Electron pulses are emitted by an electron source into the reaction chamber. A pulsed electric transfer field is generated in the reaction chamber by means of a field generator. Ions generated by the electron pulses are detected by means of a current detector. The ionic current caused by the ions is quantitatively determined by a measuring device arranged downstream of the current detector. The ions are moved from the pulsed transfer field extending up to the current detector to the current detector.

According to the invention, the current detector is arranged in the gas detector in the reaction chamber and the pulsed transfer field extends up to the current detector. Since the pulsed transfer field extends up to the current detector, a separate barrier grid and a separate drift space are not necessary. It is thus possible to arrange the current detector in the reaction chamber, so that an especially compact gas sensor is obtained, which is especially suitable for threshold detection.

An analysis unit, which has a comparison unit, is correspondingly arranged, as a rule, downstream of the measuring device. The comparison unit generates a warning signal when a measured signal generated by the measuring device exceeds a predetermined limit value. Such a gas detector can be used, for example, for filter depletion indication.

The pulse width of the electron pulses emitted by the electron source is between 1 μsec and 100 μsec, especially between 1 μsec and 10 μsec or between 10 μsec and 100 μsec. The degree of ionization can be determined by varying the duration.

The kinetic energy of the electrons is typically between 4 keV and 20 keV. The ionization area is thus limited to an area located directly in front of an entry window, through which the electrons generated by the electron source enter the reaction chamber. A usually sufficiently long drift section is thus obtained from the ionization area to the current detector arranged within the reaction chamber. The field intensity of the transfer field is selected, in general, between 10 V/cm and 10,000 V/cm. Since lengths in the range of 1 mm to 1 cm are intended for the drift section, pulse voltages within a range of 1 V and 10,000 V are needed.

The width of the transfer field pulse should be at least 10 μsec, so that a sufficient number of ions can reach the ion detector.

To make it possible to select the ions according to the recombination time, the electron pulse of the electron source and the transfer field pulse are offset in time. For example, certain ions, whose recombination time is shorter than the distance in time between the electron pulse and the transfer field pulse, can be excluded from detection in this manner.

The time offset between the electron pulse and the transfer field pulse is, in general, in the range above 15 μsec, because typical recombination times of ions may also fall within this range.

Selective operation of the gas detector, during which different ion species are detected, is also possible by varying the time offset. For example, the time offset may vary alternatingly between at least two different time values.

It is of particular interest if the shorter offset is at least 150 μsec and the longer offset is at least 200 μsec.

The release of electrons in the electron source can be based on thermal emission or field emission.

An especially compact design is obtained if the field emitter, which emits the free electrons, is formed by the ends of a plurality of elongated carbon bodies, which are arranged next to each other and which may be, for example, carbon nanotubes.

Finally, it shall be pointed out that the gas detector may both be connected to a pump, by which the gas to be analyzed can be fed from the reaction chamber, and provided with a feed device, by which the gas to be analyzed can be fed passively to the reaction chamber.

Other features and properties of the present invention appear from the following description, in which exemplary embodiments of the present invention are explained in detail on the basis of the drawings. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic view of a first exemplary embodiment of an electron source of a gas detector according to the invention;

FIG. 2 is a schematic view showing an alternative embodiment of the bottom of the electron source from FIG. 1;

FIG. 3 is a schematic view showing another alternative embodiment of the bottom of the electron source from FIG. 1;

FIG. 4 is a schematic view showing another alternative embodiment of the bottom of the electron source from FIG. 1;

FIG. 5 is a schematic view showing an alternative embodiment of the cover of the electron source from FIG. 1;

FIG. 6 is a schematic view showing another alternative embodiment of the cover of the electron source from FIG. 1;

FIG. 7 is a schematic view showing another alternative embodiment of the cover of the electron source from FIG. 1;

FIG. 8 is a schematic view showing another alternative embodiment of the cover of the electron source from FIG. 1;

FIG. 9 is a schematic view of another exemplary embodiment of an electron source;

FIG. 10 is an alternative embodiment of an electron substrate and an extraction grid of the electron source from FIG. 9;

FIG. 11 is another alternative embodiment of an electron substrate and an extraction grid of the electron source from FIG. 9;

FIG. 12 is a schematic view of the electron source from FIG. 1 with a shield;

FIG. 13 is a synoptic view of the assembly units of a gas detector;

FIG. 14 is a pulse diagram, which illustrates the time sequence of the electron pulse and of the transfer field pulse during the operation of the sensor from FIG. 13;

FIG. 15 is a diagram showing the time course of the recombination of reactant ions and analyte ions in the reaction chamber of the gas sensor from FIG. 13;

FIG. 16 is a view of an application of the gas sensor from FIG. 13;

FIG. 17 is another possible pulse diagram during the operation of the gas sensor from FIG. 13; and

FIG. 18 is an exemplary embodiment of the construction of the gas sensor from FIG. 13.

### DESCRIPTION OF THE PREFERRED EMBODIMENTS

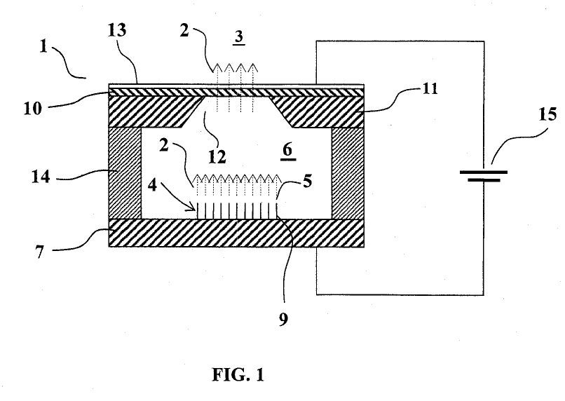

Referring to the drawings in particular, FIG. 1 schematically shows the construction of an electron source 1, which is characterized by a simple and compact design, low energy consumption as well as high electron density and, contrary to conventional field emitters, makes possible the emission of free electrons 2 into an ionization area 3 outside the arrangement and under atmospheric pressure. The electrons are at first generated by a field emitter 4. In particular, free electrons 2 are at first emitted at nanostructured field emitter tips 5 based on very high field intensities greater than 10⁹ V/m at the field emitter tips 5 and are accelerated in an interior space 6 designed as a vacuum chamber at 10⁻³ to 10⁻⁷ mbar in the direction of the ionization area 3. The field emitter tips 5 are formed by carbon nanotubes 9, which are fastened to an electrically conductive or semiconducting emitter substrate 7. Carbon nanotubes with a diameter smaller than 5 μm and especially smaller than 1 μm are especially suitable. Diameters of 10 μm to 100 μm are especially advantageous.

The ratio of the length to the diameter of the carbon nanotubes should be at least greater than 2 and preferably greater than 20. Lengths of 5 μm to 100 μm are especially advantageous.

Aluminum, highly doped silicon or silicon are especially suitable for use as substrate materials for the electrically conductive or semiconducting substrate 7.

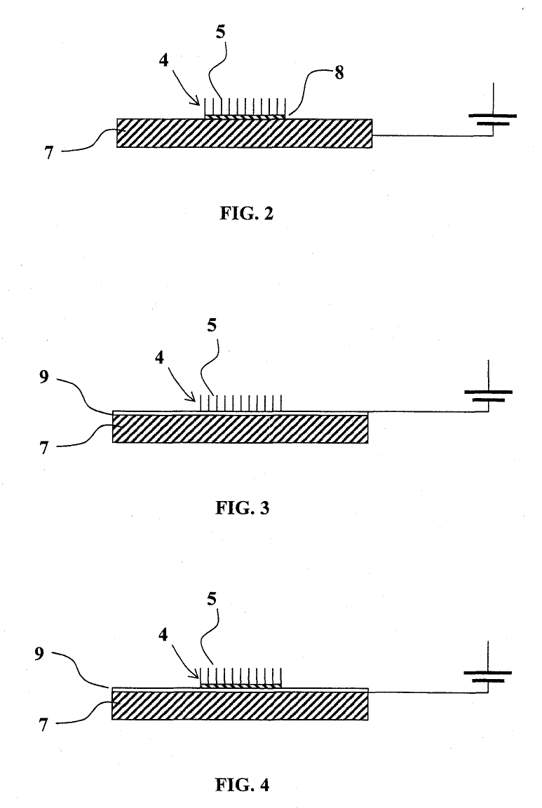

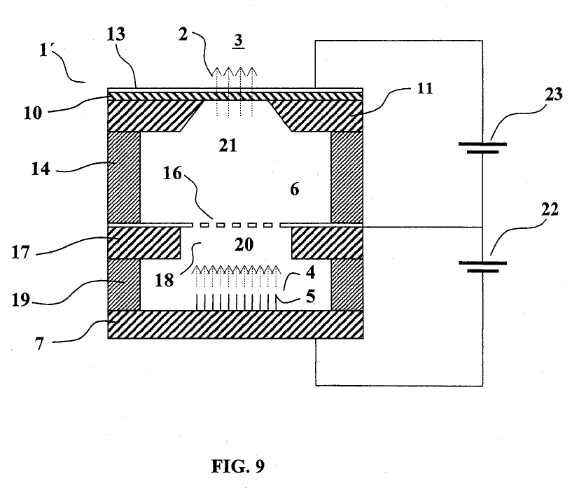

The use of carbon nanotubes as field emitter tips 5, which are fastened to an electrically conductive or semiconducting emitter substrate 7, is advantageous. The emitter substrate 7 is ideally a plate of a thickness of 0.5 mm to 2 mm made of, for example, aluminum, highly doped, electrically conductive silicon or silicon with a base of 10×10 mm² to 30×30 mm². The carbon nanotubes are usually deposited, as is described, for example, in U.S. Pat. No. 6,863,942B2, on a catalyst layer 8 shown in FIG. 2 (U.S. Pat. No. 6,863,942 is hereby incorporated by reference in its entirety). Suitable catalyst layers 8 based on transition metals, alloys or oxides thereof, are ideally applied in the form of nanoparticles on the emitter substrate 7. Especially advantageous are catalyst layers 8 from iron, cobalt or nickel particles as well as iron oxide particles. Suitable are carbon nanotubes with a diameter smaller than 5 μm and ideally smaller than 1 μm. Especially advantageous are diameters of 10 nm to 100 nm. The ratio of the length to the diameter of the carbon nanotubes should be at least greater than 2 and ideally greater than 20. Lengths of 5 μm to 100 μm are especially favorable. To avoid shielding effects and for a high electron emission, adjacent carbon nanotubes should have a distance greater than twice their height. Densities of 10⁶ to 10⁹ carbon nanotubes per cm² are advantageous. Especially favorable are densities around 10⁶ carbon nanotubes per cm². The area of the emitter substrate 7 coated with carbon nanotubes is ideally centered centrally in relation to the emitter substrate 7 and has an area smaller than 10×10 mm². Especially advantageous is a coating of the area of the emitter substrate 7, which area is located opposite a window 12 in a membrane substrate 11. The carbon nanotubes are ideally distributed uniformly over the area coated with carbon nanotubes. In case of a rotationally symmetrical design of the electron source 1 shown in FIG. 1 or of the electron source 1′ shown in FIG. 9, the edge lengths are defined as diameters. Various embodiments of carbon nanotubes and carrier substrates are already available commercially, for example, from NanoLab, Newton, Mass. 02458, USA.

FIGS. 3 and 4 show alternative embodiments with an electrically nonconductive or semiconducting emitter substrate 7, for example, from silicon.

An additional electrode layer 9 on the emitter substrate 7, for example, made of aluminum, contacts the field emitter tips 5 or the catalyst layer 8.

A thin membrane 10 (FIG. 1), which is permeable to electrons but impermeable to gases, separates the interior space 6 forming a vacuum chamber from the ionization area 3, so that ionization of the analyte can take place in the ionization area 3, for example and preferably under atmospheric pressure.

An especially suitable membrane material is silicon nitride, which is applied stress-free and preferably with a thickness of 200 nm to 600 nm to the membrane substrate 11, for example, from silicon.

By structuring the membrane substrate 11, for example, by means of wet chemical etching in a potassium hydroxide solution, a window 12 can be prepared in the membrane substrate 11 with a dimension of, for example, 1 mm×1 mm, which is closed gas-tightly by membrane 10.

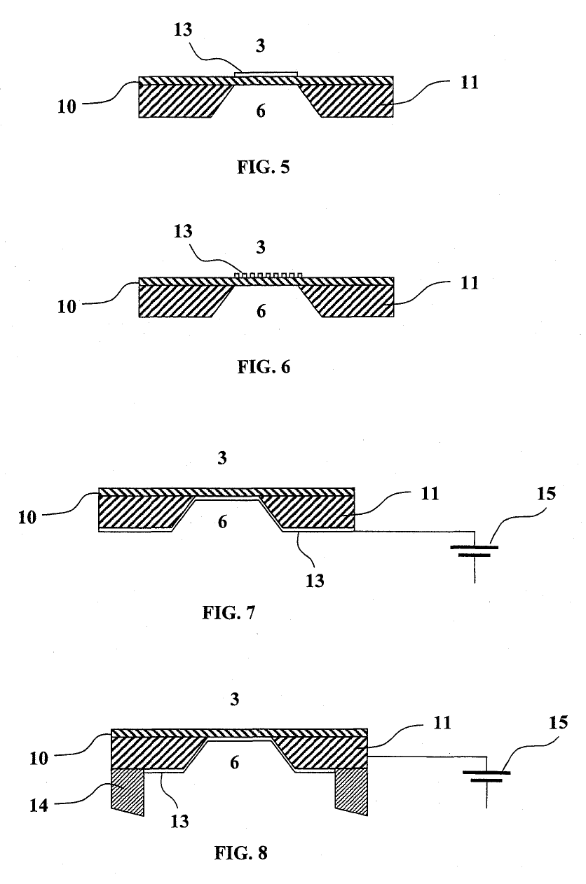

Based on the voltage applied from the outside, the electrons pass through membrane 10 and a thin electrode layer 13 applied to membrane 10 from the vacuum chamber and into the ionization area 3. As is shown in FIGS. 5 and 6, the electrode layer 13 is limited in its area to the area of window 12 and/or is made in the form of a grid. The depth of penetration of the electrons into the ionization area 3 depends, among other things, on the pressure in the ionization area 3 and the kinetic energy of the electrons 2 during entry into the ionization area 3.

Under atmospheric pressure and if the energy of the electrons 2 equals 3 keV, the depth of penetration in air is about 2 mm. Electron energies of 3 keV to 60 keV are favorable.

An aluminum layer with a thickness of 20 nm to 200 nm, which is deposited on membrane 10 and is optionally structured in the form of a grid, is suitable for use as an electrode layer 13.

The electrode layer 13 forms the counterelectrode necessary for the field emission and acceleration of the electrons 2 to the field emitter tips 5. The electrode layer 13 is formed in a flat form or in the form of a grid preferably in the area of window 12 only to focus the electrons 2 in the direction of window 12.

The electrode layer 13 is applied in the exemplary embodiment shown in FIG. 7 on the side of the membrane substrate 11 facing away from the ionization area 3 and is designed according to one of said variants.

FIG. 8 shows another exemplary embodiment. The local extension of the electrode layer 13 including the feed lines is limited to the inner wall of the vacuum chamber in the interior space 6. Substrate 11 is highly doped and electrically conductive or metallic in this embodiment. The circumferential wall 14 shown in FIG. 1, which acts as a spacer, is preferably made of glass and has a height of 2 mm to 20 mm, insulates the emitter substrate 7 against the membrane substrate 11 or the electrode layer 13 acting as a counterelectrode. The potential difference between the field emitter tips 5 and the electrode layer 13 is generated according to FIG. 1 by means of the external power source 15.

Integration of a metallic extraction grid 16, which is applied, for example, as is shown in FIG. 9 to another electrode substrate 17 with an opening 18, is advantageous for pulsed operation of the electron source 1′ according to FIG. 9. Suitable materials for the extraction grid 16 are gold, platinum or aluminum.

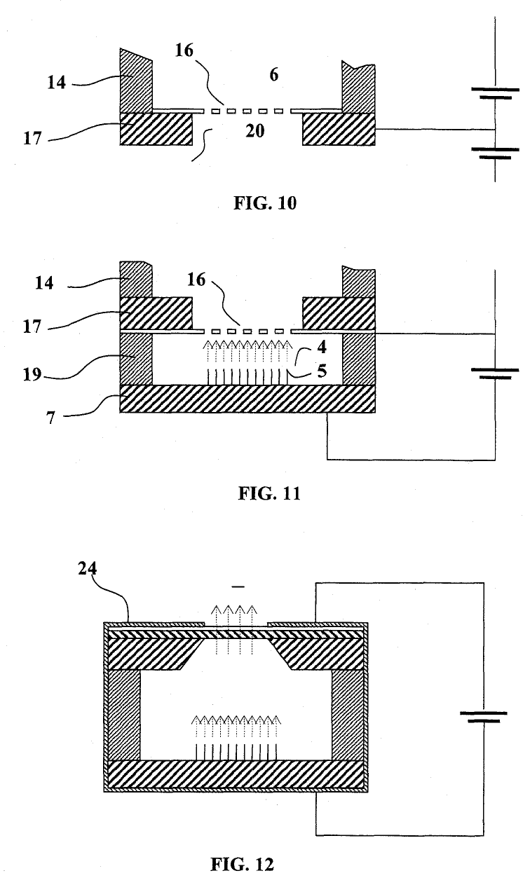

FIG. 10 shows an alternative embodiment of the extraction grid 16. The local extension of the extraction grid 16 including the feed lines is limited to the inner wall of the vacuum chamber.

The other electrode substrate 17 is highly doped and electrically conductive or metallic in this exemplary embodiment corresponding to FIG. 9. A spacer 19 made preferably of glass insulates the electrode substrate 17 against the emitter substrate 7 in the bottom area.

The electron source 1′ according to FIG. 9 has an accelerating chamber 21 separated from the extraction chamber 20. The extraction voltage and the accelerating voltage are set independently from each other with two power sources 22 and 23.

The individual components of the electron sources 1 or 1′ are manufactured individually separately and subsequently assembled. Assembly is performed in one step or sequentially, and at least the last joining step takes place under vacuum at 10⁻³ to 10⁻⁷ mbar.

The components are especially preferably bonded anodically under vacuum. The distance between the extraction grid 16 and the field emitter tip 5 is as short as possible for a high extraction field intensity at a low potential difference.

In a modified exemplary embodiment, the extraction grid 16 is applied according to FIG. 11 on the side of the electrode substrate 17 facing the field emitter tips 5. Spacer 19 has especially a height of 50 μm to 500 μm.

FIG. 12 shows another advantageous exemplary embodiment with a shield 24, which shields the electron sources 1 or 1′ against external electric and magnetic fields. Suitable shielding materials consist of μ-metals or alloys thereof, such as nickel-iron alloys.

The electron sources 1 and 1′ can be used, in principle, as electron or ionization sources in all measuring means that are based on a chemical gas-phase ionization of the analytes under atmospheric pressure.

The electron sources 1 and 1′ are especially advantageous in respect to the small overall size and simple construction and the possible gas-tight assembly under vacuum, so that no vacuum pump is needed during measurement.

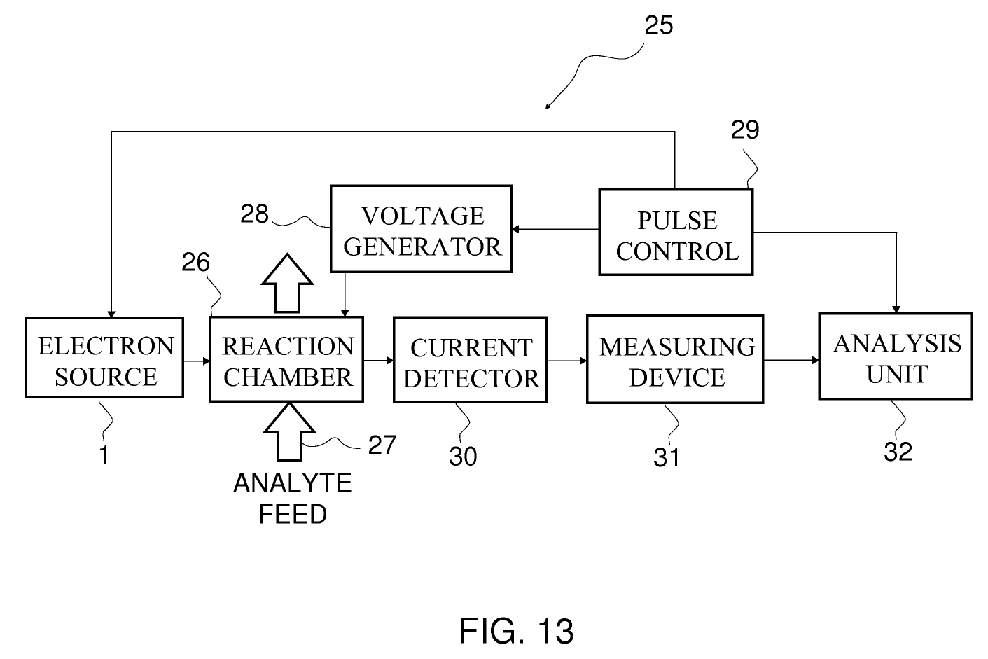

The electron sources 1 and 1′ are especially suitable for use in ion mobility spectrometers or in gas sensors 25 of the type shown in FIG. 13. Gas sensor 25 has, besides the electron source 1, a reaction chamber 26, to which a sample gas 27 can be fed, which contains the analyte to be detected. Gas sensor 25 has, furthermore, a voltage generator 28, which is controlled by a pulse control 29. Pulse control 29 also controls the electron source 1. Reaction chamber 26 is equipped, furthermore, with a current detector 30, which is followed by a measuring device 31 and which is connected to an analysis unit 32.

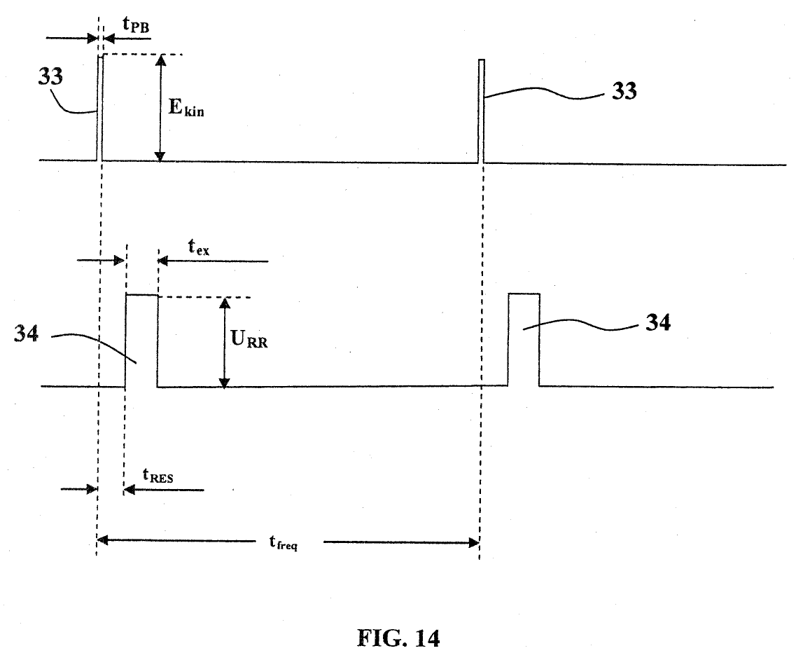

FIG. 14 shows, furthermore, a pulse diagram, which shows the course of electron pulses 33 and transfer field pulses 34 over time.

The electron source 1 is induced by the pulse control 29 to emit the electron pulses 33 into the reaction chamber 26. The electron pulses 33 with a pulse width t_{PB} and a frequency off, f_{H}=1/t_{freq} thus act in reaction chamber 26 on the analyte-containing air introduced into the reaction chamber 26 in an active or passive manner. Primary ions and ultimately both positive and negative reactant ions are formed in the ionization area 3 by the bombardment with electrons 2. The reactant ions may be, for example, hydronium ions. These hydronium ions release a proton to the analyte molecules with a sufficiently high proton affinity, as a result of which the analyte ions are formed. Negative ions are formed by electron capture (e.g., O₂— or OH—) with subsequent clustering by addition of neutral molecules.

The voltage generator 28 can be induced by the pulse control 29 by applying an electric potential U_{RR} for a time tₑₓ to form the transfer field pulses 34 in the reaction chamber 26, by which transfer field pulses the positive and negative reactant ions and analyte ions are separated from each other and fed to the current detector 30.

The various ion species can be distinguished especially by the selection of the distance in time between the injection of the electron pulse 33 into the reaction chamber 26 and the application of the transfer field pulse 34, because the ions present recombine with different recombination times. The distance in time between the end of electron pulse 33 and the beginning of the transfer field pulse 34 will hereinafter also be called residence time t_{RES}.

Based on the residence time t_{RES} set and the ionic current measured by means of measuring device 31, an analysis unit 32 arranged downstream of measuring device 31 can then determine the species and the concentration of the ions in the sample gas 27.

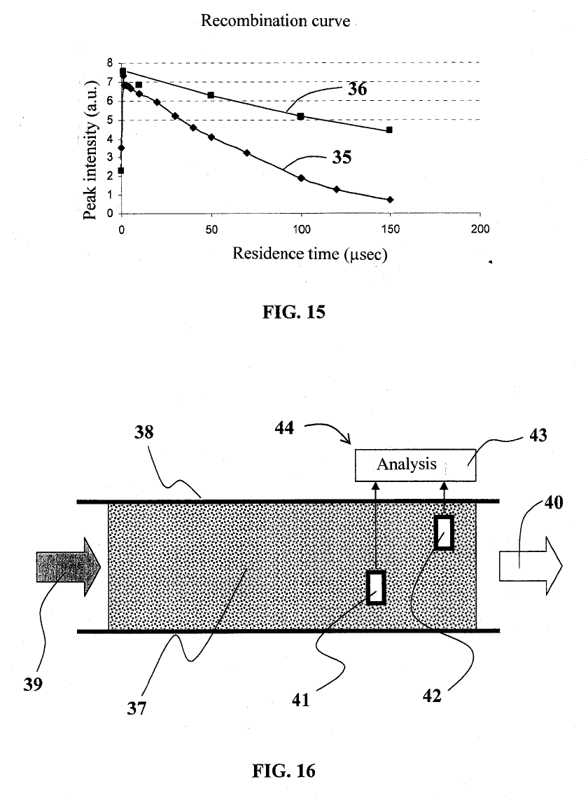

The selectivity of the gas sensor 25 that can be obtained on the basis of different residence times t_{RES} is illustrated further in FIG. 15. A curve 35 with diamond-shaped data points in FIG. 15 shows how the concentration of the reactant ions decreases with increasing residence time t_{RES}.

In the example shown in FIG. 15, an electron pulse with a width of 1 μsec was emitted with 70 keV electrons into the reaction chamber 26, in which analyte-free air was present, and the ionic current was measured for different residence times t_{RES .}

If analytes, for example, analytes with a high proton affinity, are also present in the reaction chamber 26 besides the usual air molecules, the recombination may take place significantly more slowly.

A curve 36 shown in FIG. 15 with square data points shows the course of the recombination of analyte ions with high proton affinity.

It is frequently impossible to distinguish reactant and analyte ions from one another with the sensor design of the gas sensor 25 shown in FIG. 13 and the pulse curves shown in FIG. 14. However, if analyte molecules with high proton affinity are present in the reaction chamber, the ionic current is markedly higher, as is shown in FIG. 15, after a defined residence time t_{RES} because of the recombination taking place significantly slower than in pure air. This is an indicator of the presence of analyte molecules.

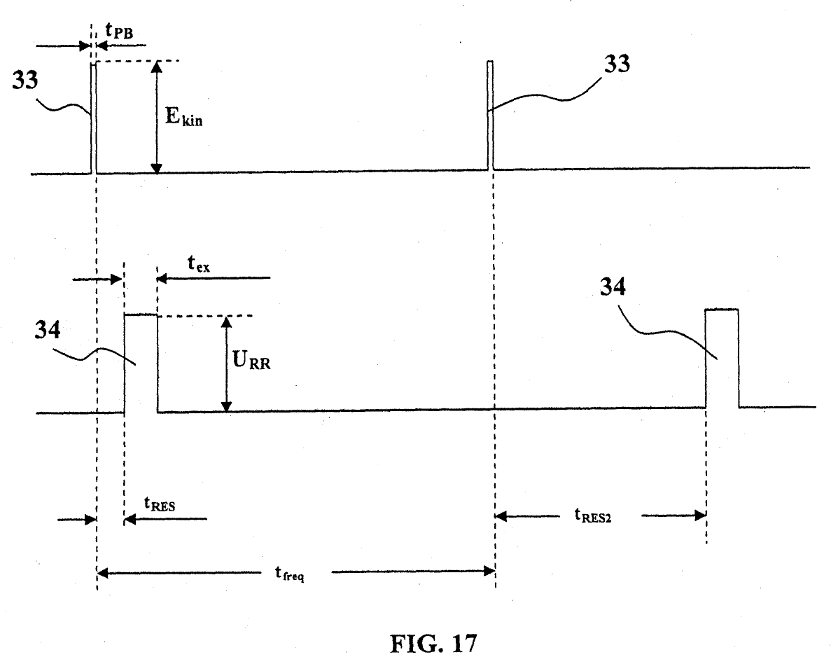

Such a highly selective gas sensor 25 may be integrated, for example, in a filter bed 37. FIG. 16 shows an exemplary embodiment of such a filter bed 37, which is arranged in a housing 38. Housing 38 may be a pipeline, which feeds air 39 flowing in to the filter bed 37 and removes air 40 flowing out. Gas sensors 41 and 42 of the type of the gas sensor 1′, which are connected each to an analysis unit 43, are arranged offset one after another in the direction of flow in the filter bed 37. Analysis unit 43 may optionally also assume the energy supply of the gas sensors 41 and 42. The air 39 flowing in, which may possibly contain harmful substances, is freed from harmful substances in a new filter bed 37 and both gas sensor 41 and gas sensor 42 come into contact with purified air only. The filter bed 37 is increasingly loaded with increasing operating time and the harmful substances reach at first gas sensor 41 after a certain time. This responds to the presence of the harmful substances and thus generates a signal that is different from that of gas sensor 42.

The signal differences detected during the analysis of the gas sensors 41 and 42 can therefore be used to indicate filter depletion.

The advantage of the sensor system 44 formed with the gas sensors 41 and 42 as well as analysis unit 43 is that even very low concentrations of harmful substances (lower ppb range), especially chemical warfare agents, can be detected by the sensor system 44.

If no other molecules that can be protonated are present in reaction chamber 26 (FIG. 13) besides a selected analyte, the analyte can also be determined quantitatively, since the ion intensity increases with increasing concentration after a selectable residence time t_{RES}. The reactant ions are recombined by this point in time and make no significant contribution to the residual ion signal any longer, so that only analyte ions can be detected.

A certain selectivity of the gas sensor 25 can also be achieved by using at least two different residence times, for example, alternatingly. A pulse diagram for such a mode of operation of the gas sensor 25 is illustrated in the pulse diagram in FIG. 17. The residence time between the electron pulses 33 and the transfer field pulses 34 alternatingly assumes the values t_{RES} and t_{RES2} in the mode of operation shown in FIG. 17.

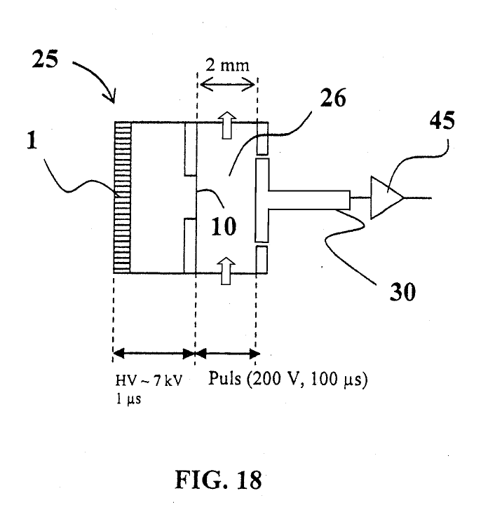

Finally, FIG. 18 shows the construction of an exemplary embodiment of gas sensor 25. The gas sensor 25 shown in FIG. 18 has an electron source 1 of the type described on the basis of FIGS. 1 through 12. Electron source 1 has a height of a few mm, and the reaction chamber formed directly in front of membrane 10 also has a depth of a few mm. Current detector 30 is arranged opposite the window 12 of the electron source 1, and said current detector 30 is joined by a pre-amplifier 45. A gas sensor 25 thus equipped is especially suitable for use in a filter bed 37 of the type shown in FIG. 16.

The electron pulse has a pulse width t_{PB}=1 μsec and the electrons have a kinetic energy Eₖᵢₙ=7 keV. The extraction pulse takes place after a residence time t_{RES}=150 μsec with a voltage gradient U_{RR}=200 V at a pulse width tₑₓ=100 msec. The pulse is repeated every 10 μsec, i.e., it has a frequency of f_{H}=100 Hz. Corresponding to FIG. 15, the ion intensity will then have a value of <1. If an analyte with high proton affinity is present in the reaction chamber, the ion intensity increases to >1. Changes in intensity in the lower ppb range can thus be detected.

It shall finally also be pointed out that features and properties that were described in connection with a certain exemplary embodiment may also be combined with another exemplary embodiment, unless this is ruled out for reasons of compatibility.

Finally, it shall also be pointed out that the singular in the claims and in the specification includes the plural, except when something else emerges from the context. Both the singular and the plural are meant especially when the indefinite article is used.

While specific embodiments of the invention have been described in detail to illustrate the application of the principles of the invention, it will be understood that the invention may be embodied otherwise without departing from such principles.

What is claimed is:

1. A gas detector for monitoring the concentration of a gas, the gas detector comprising:
a reaction chamber, to which the gas to be monitored is fed;
a pulsable electron source for emitting electrons in electron pulses into the reaction chamber;
a field generator for generating a pulsed electric transfer field in the reaction chamber, the pulsed transfer field extending up to the current detector;
a current detector for detecting an ionic current caused by the electrons in the reaction chamber and detecting the pulsed electric transfer field in the reaction chamber, the current detector being arranged in the reaction chamber; and
a measuring device arranged downstream of the current detector and by which ionic current can be quantitatively determined.

2. A gas detector in accordance with claim 1, further comprising an analysis unit including a comparison unit, the measuring device being followed by the analysis unit, the comparison unit generating a warning signal when a measured signal generated by the measuring device exceeds a predetermined limit value.

3. A gas detector in accordance with claim 1, wherein a pulse width of the electron pulses is between 1 μsec and 10 μsec or between 10 μsec and 100 μsec.

4. A gas detector in accordance with claim 1, wherein a kinetic energy of the electrons is between 4 keV and 10 keV or between 10 keV and 20 keV.

5. A gas detector in accordance with claim 1, wherein the pulsed electric transfer field has a field intensity between 10 V/cm and 1,000 V/cm or between 1,000 V/cm and 10,000 V/cm.

6. A gas detector in accordance with claim 1, wherein a width of a transfer field pulse is at least 10 μsec.

7. A gas detector in accordance with claim 1, wherein the electron pulse of the electron source and a subsequent transfer field pulse of the pulsed transfer field are offset in time.

8. A gas detector in accordance with claim 7, wherein a time offset between the electron pulse and the transfer field pulse is greater than 15 μsec.

9. A gas detector in accordance with claim 7, wherein the time offset varies alternatingly between at least two different values.

10. A gas detector in accordance with claim 9, wherein the time offset includes a shorter offset and a longer offset and the shorter offset equals at least 150 μsec and the longer offset equals at least 200 μsec.

11. A gas detector in accordance with claim 1, wherein the release of the electrons in the electron source is based on thermal emission.

12. A gas detector in accordance with claim 1, wherein the release of the electrons in the electron source is based on field emission.

13. A gas detector in accordance with claim 12, wherein a field emitter, which emits free electrons, is formed by ends of a plurality of elongated carbon bodies arranged next to each other.

14. A gas detector in accordance with claim 13, wherein the field emitter is formed from carbon nanotubes.

15. A gas detector in accordance with claim 1, wherein the reaction chamber is connected to a pump, by which the gas to be analyzed can be fed into the reaction chamber.

16. A gas detector in accordance with claim 1, wherein the reaction chamber is provided with a feed device, by which the gas to be analyzed can be fed passively into the reaction chamber.

17. A process for monitoring a concentration of a gas, the process comprising the steps of:
feeding the gas to be monitored into a reaction chamber of a gas detector;
emitting electron pulses by an electron source into the reaction chamber;
generating a pulsed electric transfer field in the reaction chamber by means of a field generator;
detecting ions generated by the electron pulses by means of a current detector;
quantitatively determining an ionic current caused by the ions by a measuring device arranged downstream of the current detector; and
moving the ions from the pulsed transfer field extending up to the current detector to the current detector.
